(19) United States
(12) Patent Application Publication
(10) Pub. No.: US 2017/0270480 A1
(43) Pub. Date: Sep. 21, 2017

(54) ENHANCEMENT OF PRODUCT OR SERVICE BY OPTIMIZING SUCCESS FACTORS

(71) Applicant: MICROSOFT TECHNOLOGY LICENSING, LLC, Redmond, WA (US)

(72) Inventors: Muiris Woulfe, Dublin (IE); Albert Agraz Sanchez, Dublin (IE); Poornima Muthukumar, Dublin (IE); Andreas Balzer, Dublin (IE); Yuanyuan Dong, Dublin (IE)

(21) Appl. No.: 15/073,016

(22) Filed: Mar. 17, 2016

(51) Int. Cl. G06Q 10/10

(52) U.S. Cl. CPC G06Q 10/101

(57) ABSTRACT

A product or service is enhanced by optimizing success factors associated with the product or service. A enhancement application initiates operations to compute a predicted score (of a success of the product or service) and a suggestion to achieve the predicted score by retrieving performance and/or configuration data associated with existing products or services from a data source. The performance and/or configuration data is analyzed to generate a model of success factors associated with the existing products or services. Next, configuration conditions of a current product are received from a stakeholder. In response, predicted score(s) are computed for the success factors using the model by simulating the configuration conditions of the current product or service on the model. Furthermore, the predicted score(s) and/or suggestion(s) to achieve the predicted score(s) are provided in a visualization to the stakeholder.

### BACKGROUND

Data collection, management, and analysis have changed work processes associated product management. Automation and improvements in work processes have expanded scope of capabilities offered by businesses. With the development of faster and smaller electronics execution of mass processes at data analysis systems have become feasible. Indeed, analysis work at data centers, data warehouses, data workstations have become common business features in modern work environments. Such systems execute a wide variety of applications ranging from enterprise resource management applications to complicated analysis tools. Many such applications analyze sales.

Vast number of data sources and data types associated with a product complicate data aggregation associated with a success of the product. Indeed, updates, changes, and/or additions to performance data from different sources may cause difficulties in management of the data associated with the product. While maintaining the performance data from variety of data sources, an additional layer of complication faced by a consumer may include assessing the success of the product. Complications with multiple data sources and complexity of the performance data may lead to mismanagement of engagement with consumers to maximize the success of the product.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to enhancement of a product or service by optimizing success factor(s) associated with the product or service. In some examples, an enhancement application may retrieve performance and/or configuration data associated with existing products or services from a data source. Next, the performance and/or configuration data may be analyzed to generate a model of success factors associated with existing products or services. Furthermore, configuration conditions of a current product may be received from a stakeholder. In response, predicted score(s) for the success factors may be computed using the model by simulating the configuration conditions of the current product or service on the model. The predicted score(s) or suggestion(s) to achieve the predicted score(s) may be provided in a visualization to the stakeholder.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1A through 1C are conceptual diagrams illustrating examples of enhancing a product or service by optimizing success factors associated with the product or service, according to embodiments;

FIG. 2 is a display diagram illustrating example components of an application to enhance a product or service by optimizing success factors associated with the product or service, according to embodiments;

FIG. 3 is a display diagram illustrating components of a scheme to enhance a product or service by optimizing success factors associated with the product or service, according to embodiments;

FIG. 4 is a display diagram illustrating an example interface providing a suggestion to achieve a predicted score of a success of the product or service, according to embodiments;

FIG. 5 is a simplified networked environment, where a system according to embodiments may be implemented;

FIG. 6 is a block diagram of an example computing device, which may be used to enhance a product or service by optimizing success factors associated with the product or service, according to embodiments; and

FIG. 7 is a logic flow diagram illustrating a process for enhancing a product or service by optimizing success factors associated with the product or service, according to embodiments.

### DETAILED DESCRIPTION

As briefly described above, an enhancement application may be provided to enhance a product or service by optimizing success factors associated with the product or service. In an example scenario, the enhancement application may retrieve performance and/or configuration data associated with existing products or services from a data source. The performance and/or configuration data may include sale information and/or consumption information, among others associated with the existing products or services. Examples of the performance and/or configuration data may also include an acquisition, a price, a number of sales, a revenue, a social media share, a usage, a description, a promotion, an advertising, a media, a metadata, and/or a content, among others associated with the existing products or services. The data source may include an inventory data store.

Next, the performance and/or configuration data may be analyzed to generate a model of success factors associated with the existing products or services. The success factors may include a description, a promotion, a price, an advertising, a media, a metadata, and/or a content, among others associated with the existing products or services. Furthermore, configuration conditions of a current product or service may be received from a stakeholder. The stakeholder may include a creator, a sales associate, a sales manager, a consumer, a contributor, a seller, and/or a supporter, among others associated with the existing products or services.

The enhancement application may compute predicted score(s) for the success factor(s) using the model by simulating configuration conditions of the current product or service on the model. Predicted score(s) may include key performance indicators (KPIs). A history of the predicted score(s) associated with the current product or service (and/or existing product(s) or service(s)) may be managed or retrieved from the performance data and/or configuration to manage and/or track progress of a success of the current product through previous versions. The configuration conditions may include a description, a promotion, a price, an advertising, a media, a metadata, and/or a content, among others associated with the current product or service. A configuration condition may be an unprocessed success factor that is not analyzed and/or correlated with a success of a product or service.

Predicted score(s) and/or suggestion(s) to achieve the predicted score(s) may be provided to the stakeholder in a visualization. The visualization may include a report, a chart, and/or a notification, among others. The predicted score(s) may also be processed for a presentation as an abstraction. A binary selection may be provided as an abstraction (such as good or bad). Furthermore, a percentage of a previous score may be provided as an abstraction to compare the predicted score(s) with a previous version of the current product or service.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a physical computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components to enhance a product or service by optimizing success factors associated with the product or service. Examples of platforms include, but are not limited to, a hosted service executed over a plurality of servers, an application executed on a single computing device, and comparable systems. The term “server” generally refers to a computing device executing one or more software programs typically in a networked environment. More detail on these technologies and example operations is provided below.

A computing device, as used herein, refers to a device comprising at least a memory and a processor that includes a desktop computer, a laptop computer, a tablet computer, a smart phone, a vehicle mount computer, or a wearable computer. A memory may be a removable or non-removable component of a computing device configured to store one or more instructions to be executed by one or more processors. A processor may be a component of a computing device coupled to a memory and configured to execute programs in conjunction with instructions stored by the memory. A file is any form of structured data that is associated with text, audio, video, or similar content. An operating system is a system configured to manage hardware and software components of a computing device that provides common services and applications. An integrated module is a component of an application or service that is integrated within the application or service such that the application or service is configured to execute the component. A computer-readable memory device is a physical computer-readable storage medium implemented via one or more of a volatile computer memory, a non-volatile memory, a hard drive, a flash drive, a floppy disk, or a compact disk, and comparable hardware media that includes instructions thereon to automatically save content to a location. A user experience—a visual display associated with an application or service through which a user interacts with the application or service. A user action refers to an interaction between a user and a user experience of an application or a user experience provided by a service that includes one of touch input, gesture input, voice command, eye tracking, gyroscopic input, pen input, mouse input, and keyboards input. An application programming interface (API) may be a set of routines, protocols, and tools for an application or service that enable the application or service to interact or communicate with one or more other applications and services managed by separate entities.

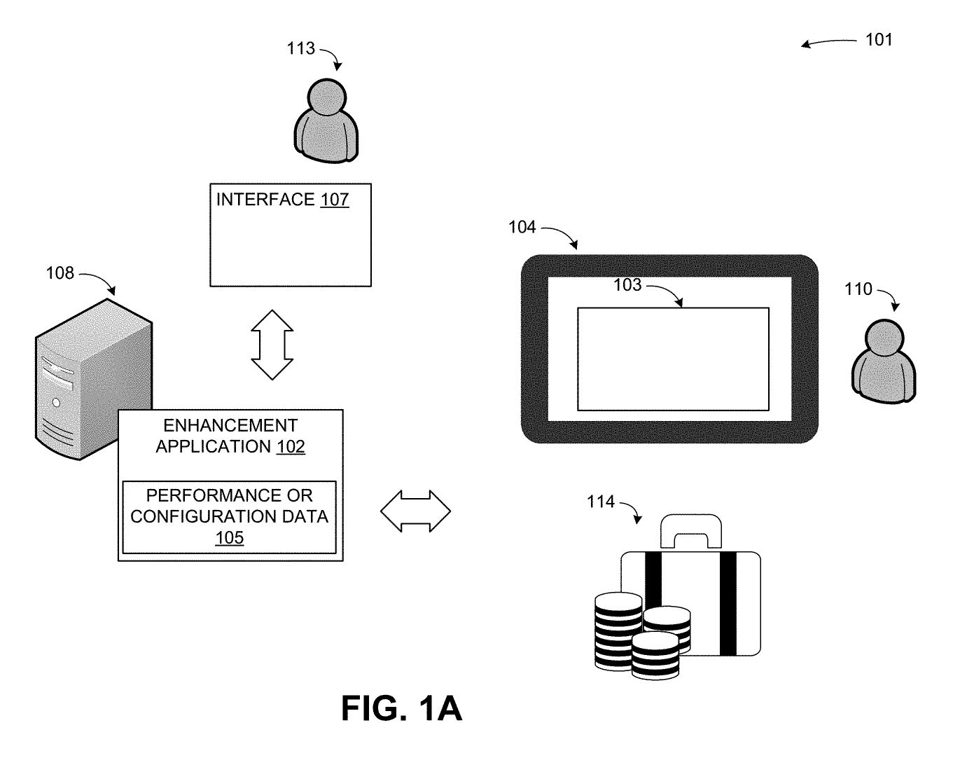

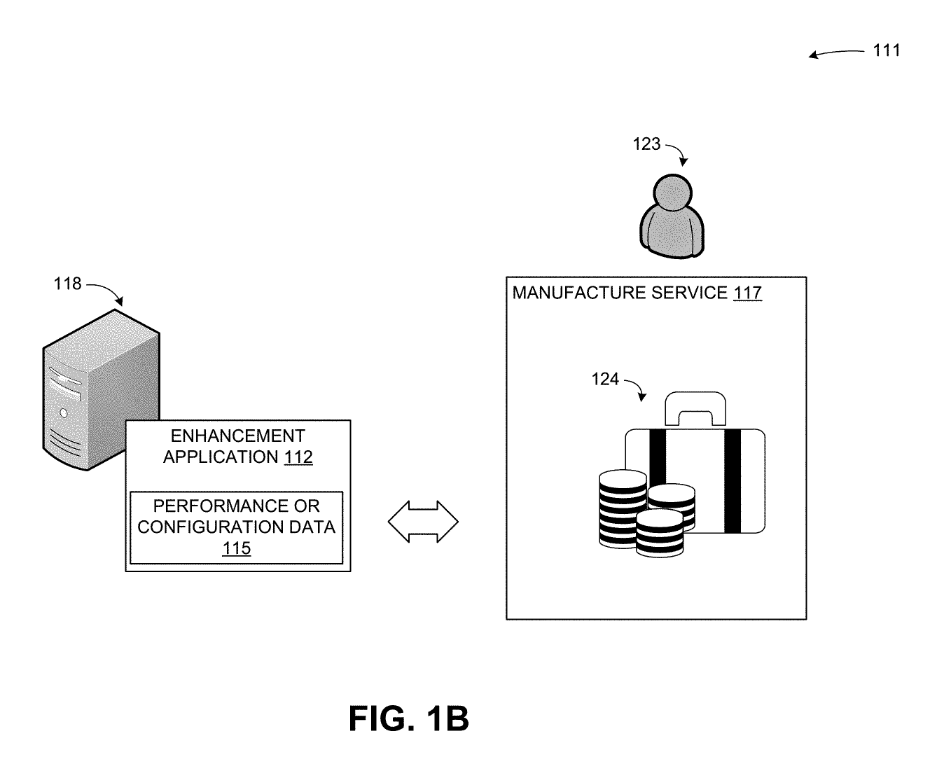

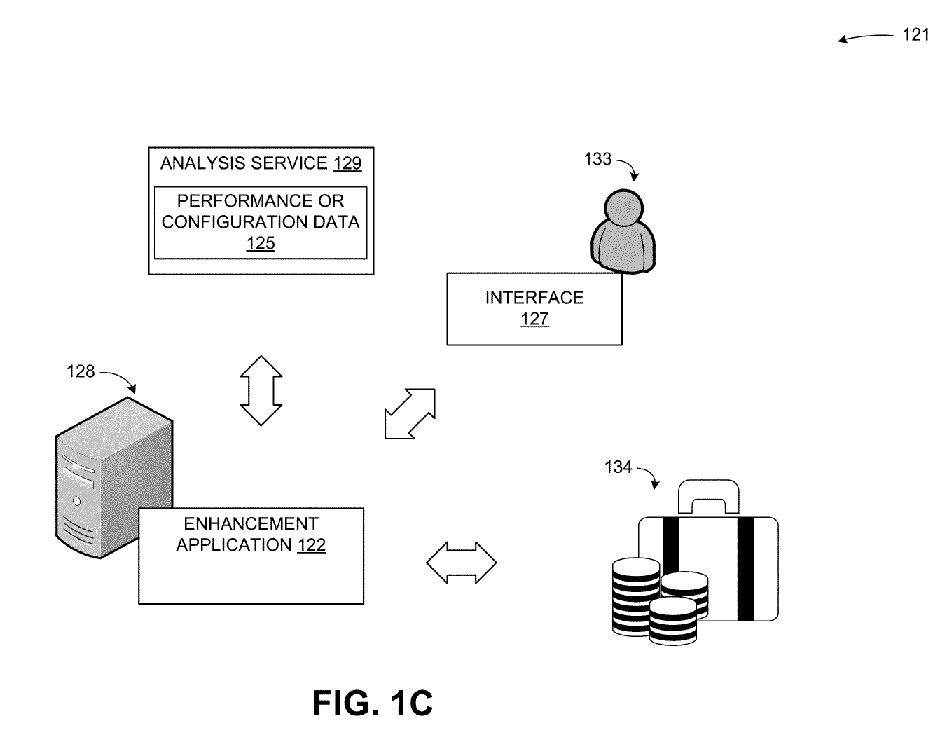

FIG. 1A through 1C are conceptual diagrams illustrating examples of enhancing a product or service by optimizing one or more success factors associated with the product or service, according to embodiments.

In a diagram 101, a computing device 108 may execute an enhancement application 102. The computing device 108 may include a physical server providing one or more services (or applications) to client devices. A service may include an application performing operations in relation to a client application and/or a subscriber, among others. The computing device 108 may also include and/or is part of a mobile device, a workstation, a data warehouse, and/or a data center, among others.

The computing device 108 may execute the enhancement application 102 to identify suggestion(s) to improve a success of the product or service (103 or 114). The enhancement application 102 may initiate operations to enhance the product or service by retrieving performance and/or configuration data 105 associated with existing products or services from a data source. The product or service 103 as discussed herein may refer to a physical product sold or otherwise provided to consumers, a software application, a software based service (e.g., access to a web application), a work based service (e.g.: a consultation service) or any combination thereof. In the example configuration of FIG. 1A, the product or service 103 may be a software application to be deployed to a consumer 110. The product or service 103 may execute in a client device 104 such as a mobile device, and/or a desktop device, among others. The product or service 103 may include a client application or a user interface for a server application. Alternatively, the product or service 114 may include a physical product such as an item for sale or consumption by the consumer 110. The consumer 110 may include an individual, groups of individuals, and/or a business, among others. The data source may include an inventory data store, and/or an enterprise resource management system, among others.

The performance and/or configuration data 105 may be analyzed to generate a model of success factor(s) associated with existing products or services. The performance and/or configuration data 105 may be processed through a machine-learning scheme which includes decision node(s). The performance and/or configuration data 105 may be split into a source data and a validation data. The source data may be used to construct the model. The validation data may be used to verify a validity of the model. For example, the source data may include historical performance measurements associated with the existing products or services. The validation data may additionally include review information such as success scores assigned to the existing products or services based on historical performance and review.

Furthermore, the performance and/or configuration data 105 may include a historical data set about the existing products or services which may include sale and consumption information regarding the existing products or services. The performance and/or configuration data 105 may include measurements associated with the product (103 or 114) such as sale information and/or consumption information, among others. The performance and/or configuration data 105 may include an acquisition, a price, a number of sales, a revenue, a social media share, a usage, a description, a promotion, an advertising, a media, a metadata, and/or a content, among others associated with the existing products or services.

Next, configuration conditions of the product or service (103, 114) may be received from a stakeholder 113. The stakeholder 113 may define the configuration conditions of the product or service (103 or 114) through an interface 107 of the enhancement application 102. The configuration conditions may include a description, a promotion, a price, an advertising, a media, a metadata, and/or a content, among others associated with the product or service (103 or 114). The stakeholder may include a creator, an owner, a contributor, and/or a supporter, among others associated with the product or service. The stakeholder 113 may wish to improve a success of the product or service (103 or 114) through an automated scheme and operations provided by the enhancement application 102. In addition, the interface 107 may include a user interface or a client interface of the enhancement application 102.

Furthermore, the analysis module may compute the predicted score(s) for the success factor(s) by simulating the configuration conditions of the product or service (103 or 114) on the model. The predicted score(s) may also be manually computed and input by the stakeholder 113 through the interface 107. The predicted score(s) may be a computed metric to evaluate a success of the product or service (103 or 114). Predicted score(s) may include key performance indicators (KPIs). A history of the predicted score(s) associated with the current product or service (and/or existing product(s) or service(s)) may be managed or retrieved from the performance data and/or configuration to manage and/or track progress of a success of the current product through previous versions. A presentation module of the enhancement application 102 may provide the predicted score(s) or suggestion(s) associated with enhancing the predicted score(s) in a visualization to the stakeholder 113. The presentation module may transmit the predicted score(s) or the suggestion(s) to the stakeholder 113 through the interface 107.

The computing device 108 may communicate with the client device 104 through a network. The network may provide wired or wireless communications between nodes such as the client device 104, or the computing device 108, among others. Previous example(s) to enhance a success of the product or service (103 or 114) through the enhancement application 102 are not provided in a limiting sense. Alternatively, the enhancement application 102 may manage the performance and/or configuration data 105 at a desktop application, a workstation application, and/or a server application, among others. The client application may also include a client interface of the enhancement application 102.

The consumer 110 or the stakeholder 113 may interact with the client application or the interface 107, respectively, with a keyboard based input, a mouse based input, a voice based input, a pen based input, and a gesture based input, among others. The gesture based input may include one or more touch based actions such as a touch action, a swipe action, and a combination of each, among others.

In a diagram 111, a stakeholder 123 may interact with a manufacture service 117 to initiate operations to enhance a success of a product or service 124. The manufacture service 117 may include an enterprise resource management system. The manufacture service 117 may interact with the enhancement application 112 (which is executed on a computing device 118) to produce predicted score(s) for success factors of the product or service 124. The enhancement application 112 may retrieve performance and/or configuration data 115 from the manufacture service 117 or another entity managing information associated with the product or service 124. The enhancement application 112 may provide results of an analysis of the performance and/or configuration data 115 to the manufacture service 117. The results may include suggestion(s) (e.g.: a description of a change to a property or a content of the product or service 124) and the predicted score(s) associated with the suggestion(s) which are provided to the manufacture service 117. The manufacture service 117 may present the predicted score(s) and/or the suggestion(s) to the stakeholder 123 and/or execute additional operations on the suggestion(s) and the predicted score(s). Furthermore, the manufacture service 117 may automatically manufacture an optimized version of the product or service 124 by using the results of the analysis of the performance and/or configuration data 115 with or without an interaction with the stakeholder 123.

In a diagram 121, an enhancement application 122 (executed on a computing device 128) may allocate operations associated with an analysis of a performance and/or configuration data 125 to an analysis service 129. The analysis service 129 may include a third party that is authorized to process the performance and/or configuration data 125 through a machine-learning scheme. The third party may produce predicted score(s) of success factors of a product or service 134 which simulate implementation of a change to configuration conditions of the product or service 134.

The performance and/or configuration data 125 (received by the analysis service 129) may also include private data which may be anonymized by the enhancement application 122 or another entity. The analysis service 129 may also interact with the data source to retrieve the performance and/or configuration data 125. Furthermore, the enhancement application 122 may interact with the stakeholder 133 through an interface 127 to present the predicted score(s) or suggestion(s) to enhance the predicted score.

While the example systems in FIG. 1A through 1C have been described with specific components including the computing device 108, the enhancement application 102, embodiments are not limited to these components or system configurations and can be implemented with other system configuration employing fewer or additional components.

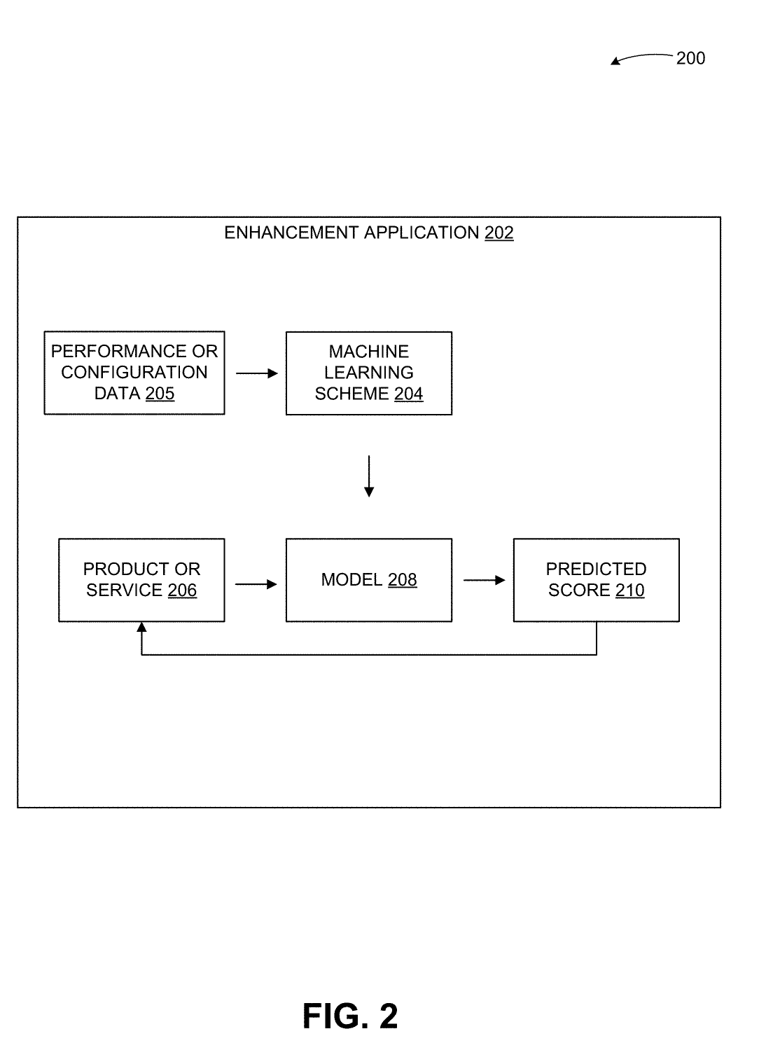

FIG. 2 is a display diagram illustrating example components of a service to enhance a product or service by optimizing success factors associated with the product or service, according to embodiments.

In a diagram 200, an enhancement application 202 may initiate operations to enhance a success of a product or service 206 by retrieving performance and/or configuration data 205 associated with existing products or services from a data source. The performance and/or configuration data 205 may include sale information, and/or consumption information, among others associated with the product or service. The enhancement application 202 may process the performance and/or configuration data 205 through a machine-learning scheme 204 to generate a model 208 of success factors associated with the existing products or services. The machine-learning scheme 204 may provide operations and decision nodes to filter the performance and/or configuration data 205.

Next, configuration conditions of the product or service 206 may be received from a stakeholder. Predicted score(s) for the success factors may be computed using the model by simulating the configuration conditions of the product or service 206 on the model 208. Suggestion(s) may be generated to achieve the predicted score(s). The suggestion(s) may describe change(s) to configuration condition(s) of the product or service 206 to improve the success of the product or service 206. The suggestion may include a change to a description, a promotion, a price, an advertising, a media, a content, a shape, a dimension, and/or among others associated with the product or service 206. The predicted score(s) may also be compared to a particular threshold to validate the predicted score(s). The particular threshold may be customizable by an entity such as a stakeholder of the product or service (e.g.: owner of the product or service). The customization may include a value such as 5%, 10%, 15%, 20%, 25%, 50%, or more above a current score of the product or service 206.

An example of the machine-learning scheme 204 may include a boosted decision regression scheme. Other examples of the machine-learning scheme 204 may include a linear scheme, a Bayesian linear scheme, a decision forest scheme, a fast forest quantile scheme, a neural network scheme, a Poisson scheme, and/or an ordinal scheme, among others.

In an example scenario, the machine-learning scheme 204 may include one or more decision nodes. The decision nodes may be evaluated with a weight factor attached to each of the decision nodes. The weight factor of each decision node is adjusted to produce a model 208 while processing the performance and/or configuration data 205 through the decision nodes. The model 208 may be used to compute a predicted score 210. The weight factor of the decision nodes are adjusted until the model 208 produces the predicted score 210 that is greater than a current score associated with the product or service 206 (that is not changed). The predicted score 210 may be provided with or without a suggestion that includes a change to configuration conditions of the product or service 206.

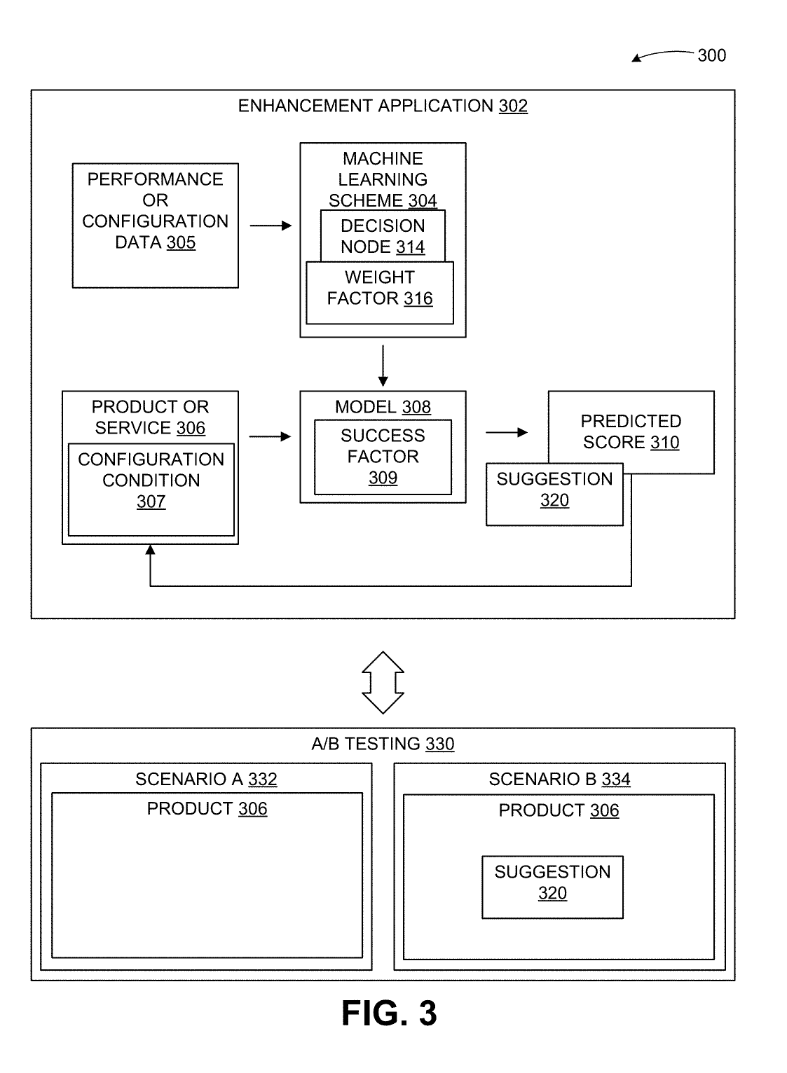

FIG. 3 is a display diagram illustrating components of a scheme to enhance a product or service by optimizing success factors associated with the product or service, according to embodiments.

In a diagram 300, an enhancement application 302 may process a performance and/or configuration data 305 associated with a product or service 306 through a machine-learning scheme to produce a model 308. The performance and/or configuration data 305 may include measurements (such as sales and consumption) of existing products or services. A machine-learning scheme 304 may include a decision node 314 that is used to process the performance and/or configuration data 305. Furthermore, the decision node 314 may include one or more steps to assess a value of a success factor 309. The success factor 309 (and other success factors) of the existing products or services may be used to process configuration conditions of the product or service 306. The decision node 314 may correlate with a success factor (such as a property) of the existing products or services. The success factor 309 and others may be used to generate the model 308 to process configuration conditions of the product or service 306.

A suggestion 320 may be identified by analyzing a configuration condition 307. For example, the configuration condition 307 may be processed through a historical data set of suggestions (that are related to model 308). Matching suggestion(s) may be identified as the suggestion 320. An example of the suggestion 320 may include a change to a configuration condition 307 of the product or service 306 such as a price related change, a documentation change, and/or a naturalization change, among others. An implementation of the suggestion 320 to the product or service 306 may be simulated to compute a predicted score 310.

While generating the model 308, a weight factor 316 may be assigned to a decision node 314 which corresponds to a success factor 309. The weight factor 316 may be a value assigned to the decision node 314 that establishes a correlation between the decision node 314 and the success factor 309. The weight factor 316 may distinguish the success factor 309 that is likely to contribute to a success of the product or service 306 when implemented.

The model 308 may be modified by adjusting the weight factor 316 associated with the decision node 314. The weight factor 316 may be increased to increase a value of a configuration condition (e.g.: a description of the product or service 306) of the product or service 306 while processing the configuration condition through the model 308. The weight factor 316 may be decreased to decrease the value of the configuration condition of the product or service 306 while processing the configuration condition through the model 308.

The model 308 may also be used to compute the predicted score 310 of the product or service 306 when the suggestion 320 is implemented. The suggestion 320 may be verified when the predicted score 310 (with an implementation of the suggestion 320) is greater than a current score of the product or service 306 (without an implementation of the suggestion 320). The decision node may be removed if the adjustment of the weight factor 316 produces the predicted score 310 that is lower than a current score which may indicate that the suggestion 320 fails to improve a success of the product or service 306. The decision node 315 may also be removed in response to a detection of a redundancy with another decision node of the machine-learning scheme 304.

The predicted score 310 may also be validated through a performance of an A/B testing 330. The A/B testing 330 may refer to testing a product or service with a change and without a change to evaluate performance of the product or service 306 associated with the change. The enhancement application 302 may execute operation(s) to perform the A/B testing 330 or prompt another entity to perform the A/B testing 330. A previous version of the product or service 306 may be provided to consumer(s) through a scenario A 332. A changed version of the product or service 306 (changed based on an implementation of the suggestion 320) may be provided to the consumer(s) through a scenario B 334. Each consumer may receive either the previous version or the changed version of the product or service 306. Alternatively, the roles of the scenario A 332 and the scenario B 334 may also be reversed in which a changed version of the product or service 306 is provided through the scenario A and a previous version of the product or service 306 is provided through the scenario B.

A success measurement (such as number of sales within a time period) may be tracked for the previous version and the changed version of the product or service 306. Next, the success measurement for the previous version may be compared to the success measurement for the changed version. In response to detecting the success measurement for the changed version as greater than the success measurement for the previous version, the predicted score may be validated. In response to detecting the success measurement of the previous version as greater than the success measurements of the changed version, the predicted score 310 may be invalidated. In response, the model 308 may be removed (to reprocess the performance and/or configuration data 305 with any updates to the machine-learning scheme or the existing products or services) or the decision node 314 may be removed from the decision nodes within the machine-learning scheme 304 to eliminate a failure related to the decision node 314.

Examples of the machine-learning scheme 304 were not provided in a limiting sense. Other schemes may be used by the enhancement application 302 to enhance a success of the product or service 306.

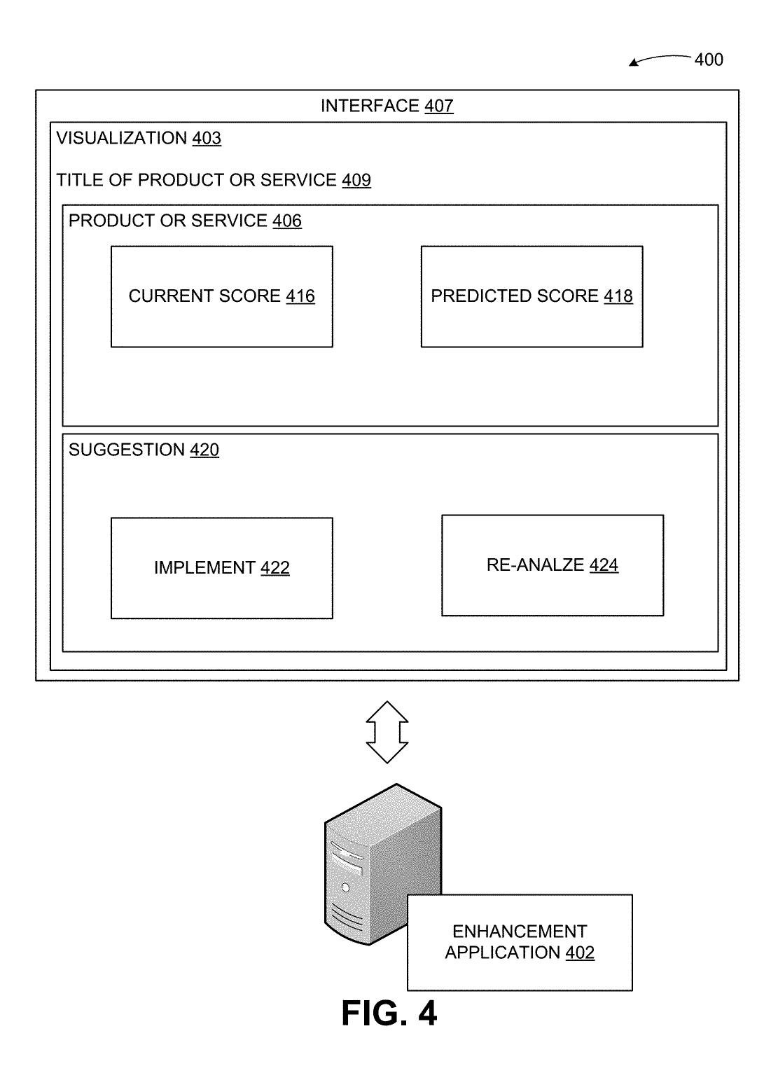

FIG. 4 is a display diagram illustrating an example interface providing a suggestion to achieve a predicted score of a success of the product or service, according to embodiments.

In a diagram 400, an enhancement application 402 may provide a visualization 403 to an interface 407 for presentation. The visualization may provide a predicted score 418 and/or a suggestion to achieve the predicted score of a product or service 406. The visualization 403 may include report(s), chart(s), presentation(s), and/or document(s), among others. The visualization 403 may also include the title of a product or service 409, other performance and/or configuration data associated with the product or service 409, and/or additional product(s) or service(s) that are associated with the product or service 409.

The visualization 403 may also provide one or more additional suggestions and one or more additional predicted scores (of one or more additional success metrics) that simulate implementation of the additional suggestions. The additional predicted scores (of the additional success metrics) and the additional suggestions (along with the suggestion 420 and the predicted score 418) may be presented through a chart or a report to illustrate an impact of the additional suggestions and the suggestion 420 on the product or service 406.

The interface 407 may present the visualization 403, which includes a title of the product or service 409, the product or service 406, a current score 416, the predicted score 418, and the suggestion 420. The suggestion 420 may be presented with the predicted score 418 and the current score 416 to show an impact of the suggestion 420 on the product or service 406. The suggestion 420 may provide details associated with the configuration conditions such as change(s) suggested for an implementation in the product or service 406. Summary and/or detailed information about the product or service 406 may also be provided with the suggestion 420.

The visualization 403 may also include control elements to implement the suggestion 420 through an implement element 422. In response to a detected activation of the implement element 422, the visualization 403 may prompt the enhancement application 402 to execute operations to implement the suggestion 420. In response, the enhancement application 402 may execute the operations to implement the suggestion 420 on the product or service 406 and re-analyze configuration conditions of the product or service 406 to re-compute the predicted score 418. The interface 407 may receive and provide the predicted score 418 (that is re-computed) to the stakeholder and any new suggestion(s) to improve the predicted score 418. Alternatively, a re-analyze element 424 may be provided to execute operations to re-calculate the predicted score 418 based on an implementation of the suggestion 420. The stakeholder may be allowed an option to re-analyze the predicted score 418 based on a detected change to the product or service 406 or a new input that includes changes to the configuration conditions, among other reasons.

An abstraction of the predicted score may also be generated and provided through the visualization 403. The abstraction may include a percentage value indicating a comparison between the predicted score 418 (of an implementation of the suggestion 420 on the product or service 406) and the current score 416 of the product or service 406. The abstraction may also indicate a percentage value of a previous predicted score of a previous version of the product or service 406 and the predicted score 418 of an implementation of the suggestion 420 on the product or service 406. An example of the abstraction value may also include binary values that specifies an improvement or a decline of a success of the product or service 406 if the suggestion 420 is implemented.

The visualization 403 may also include a description of a mechanism of how the suggestion 420 may automatically enhance the product or service 406. For example, the suggestion 420 may include a description that may specify a temporary sale to the price of the product or service 406. Additionally, the enhancement application 402 may dynamically, on schedule, and/or on demand, among others re-execute operations to enhance the product or the product or service 406 with update(s) to performance and/or configuration data of the existing product(s) or service(s) and/or configuration condition(s) of the product or service 406. Alternatively, the enhancement application 402 may also interact with the stakeholder through a communication (such as email and/or among others) to provide the suggestion 420 and control element(s) for the stakeholder to initiate the enhancements of the product or service 406 based on the suggestion 420.

Furthermore, other product(s) or service(s) may also be analyzed to generate other suggestion(s) to improve the success of the other product(s) or service(s) based on an analysis of configuration conditions through the model of success factors associated with the existing products or services. The other product(s) or service(s) may be related to the product or service 406. Results of the analysis such as additional predicted score(s) and additional suggestion(s) may be provided along with the predicted score 418 and the suggestion 420. The visualization 403 may also be used to provide information about how a manual analysis may have generated the model of success factors used to analyze the configuration conditions of the product or service 406. Control elements may be provided by the visualization 403 to adjust the manual analysis to further modify the generated model.

Control elements may also be provided to prompt the stakeholder to adjust the other product(s) or service(s). In an example scenario, the stakeholder may interact with the control elements to give preferential treatment to a selection of the product or service 406 and/or one or more of the other product(s) or service(s) by raising a price of the non-selected product(s) or service(s). Furthermore, the enhancement application 402 may suggest or automatically generate one or more additional version(s) of the product or service 406 by adapting configuration conditions. These additional version(s) may be marketed as limited or trial version(s) of the product or service 406. The purpose of these additional version(s) may influence the success of one or more other product(s) or service(s) by increasing a breadth of the product or service available to consumers.

Furthermore, the additional suggestion(s) of the other product(s) or service(s) may describe how the other product(s) or service(s) may be adjusted to influence success of the other product(s) or service(s). The enhancement application 402 may also automatically apply the suggestion 420 to the product or service 406 upon a detected approval by the stakeholder. Alternatively, the enhancement application 402 may automatically apply the suggestion 420 to the product or service 406 without a stakeholder interaction based on one or more permission or rules granting the enhancement application 402 an authority to execute operations associated with the suggestion 420. The suggestion 420 may also be provided to a manufacturing service(s) (for an implementation of the suggestion) upon an approval by the stakeholder. Alternatively, the suggestion 420 may be provided to the manufacturing service(s) without the approval of the stakeholder based on one or more permission or rules granting the enhancement application 402 an authority to transmit the suggestion 420.

In an example scenario, the enhancement application 402 may automatically re-analyze the product or service and/or other product(s) or service(s). The stakeholder (and/or other stakeholder(s)) may be contacted with an updated predicted score and/or suggestion and/or updated additional predicted score(s) or suggestion(s). Additionally, the enhancement application 402 may initiate improvement of the product or service 406 by transmitting the suggestion 420 to a manufacturing service to prompt the manufacturing service to implement operations associated with the suggestion on the product or service 406.

In another example scenario, performance and/or configuration data associated with the existing products or services may be processed manually by a stakeholder. Results of the manual analysis may be captured by the enhancement application 402. The success factors may also be selected manually by the stakeholder and provided to the enhancement application 402. Furthermore, predicted score 418 and/or other metric(s) may be provided to the stakeholder as a percentage through the interface 407. Alternatively, the predicted score 418 and/or the other metric(s) may be provided to the stakeholder as a binary value.

In another example scenario, the predicted score 418 and/or other metric(s) are presented to the stakeholder as a key performance indicator (KPI). The predicted score 418 and/or metric(s) are presented relative to the additional score(s) and/or metric(s) of other product(s) or service(s). A history of the predicted score 418 and/or other metric(s) and the suggestion 420 may also be provided for previous versions of the product or service 406. Furthermore, the model may be validated by processing a subset of the performance and/or configuration data for the existing products or services.

In another example scenario, the enhancement application 402 may automatically create additional version(s) of the product or service 406 to influence the success of other products or services associated with the product or service 406 with or without an approval by the stakeholder. Alternatively, the enhancement application 402 may interact with a manufacturing service to prompt the manufacturing service to create the additional version(s) of the product or service 406 to influence the success of other products or service associated with the product or service 406 with or without an approval by the stakeholder.

As discussed above, the enhancement application 402 may be employed to perform operations to automate an enhancement of a success of a product or service. An increased user efficiency with the client application may occur as a result of analyzing performance and/or configuration data through the enhancement application 102. Additionally, processing performance and/or configuration data to generate a model which is used to compute a predicted score associated with a suggestion to change a product or service, by the enhancement application 102, may reduce processor load, increase processing speed, conserve memory, and reduce network bandwidth usage.

Embodiments, as described herein, address a need that arises from a lack of efficiency to predict an improvement to a success of a product or service based on a change to a configuration condition of the product or service by the client application or external data sources. The actions/operations described herein are not a mere use of a computer, but address results that are a direct consequence of software used as a service offered to large numbers of users and applications.

The example scenarios and schemas in FIG. 1A through 4 are shown with specific components, data types, and configurations. Embodiments are not limited to systems according to these example configurations. Enhancing a product or service by optimizing success factors associated with the product or service may be implemented in configurations employing fewer or additional components in applications and user interfaces. Furthermore, the example schema and components shown in FIG. 1A through 4 and their subcomponents may be implemented in a similar manner with other values using the principles described herein.

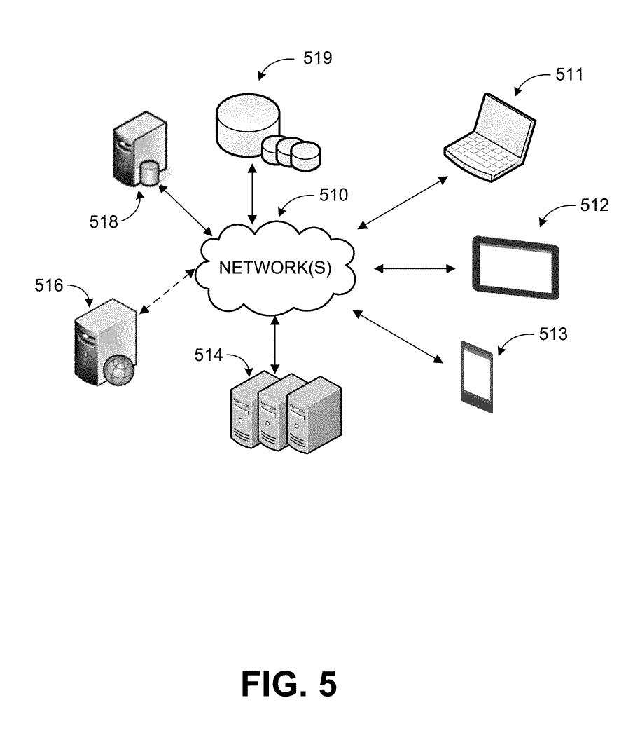

FIG. 5 is an example networked environment, where embodiments may be implemented. A enhancement application configured to enhance a product or service by optimizing success factors associated with the product or service may be implemented via software executed over one or more servers 514 such as a hosted service. The platform (or a custom device to operate the operations to enhance a success of the product or service) may communicate with client applications on individual computing devices such as a smart phone 513, a mobile computer 512, or desktop computer 511 (client devices′) through network(s) 510.

Client applications executed on any of the client devices 511-513 may facilitate communications via application(s) executed by servers 514, or on individual server 516. A enhancement application may retrieve performance and/or configuration data associated with existing products or services from a data source. The performance and/or configuration data may be analyzed to generate a model of success factor(s) associated with the existing products or services. Next, configuration conditions of a current product or service may be received from a stakeholder. In response, predicted score(s) may be computed for the success factor(s) using the model by simulating the configuration conditions of the current product or service on the model. The predicted score(s) or suggestion(s) to achieve the predicted score(s) may be provided in a visualization to the stakeholder. The enhancement application may store data associated with the product or service in data store(s) 519 directly or through database server 518.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to enhance a success of a product or service by optimizing success factors associated with the product or service. Furthermore, the networked environments discussed in FIG. 5 are for illustration purposes only. Embodiments are not limited to the example applications, modules, or processes.

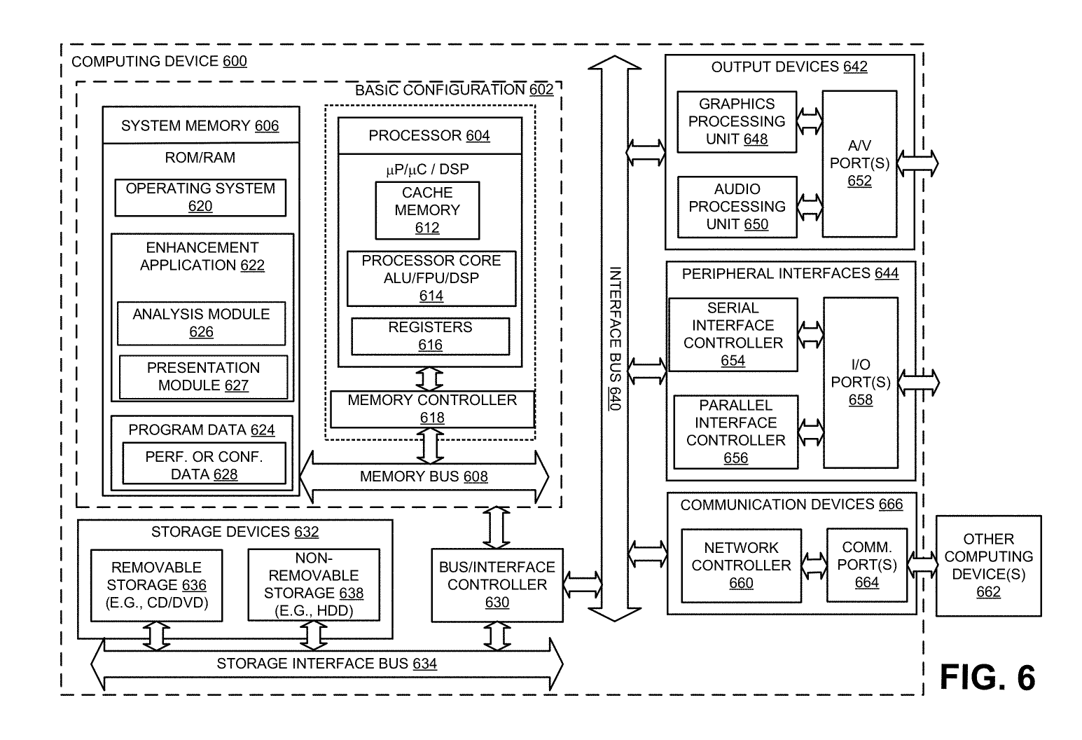

FIG. 6 is a block diagram of an example computing device, which may be used to enhance a product or service by optimizing success factors associated with the product or service, according to embodiments.

For example, computing device 600 may be used as a server, desktop computer, portable computer, smart phone, special purpose computer, or similar device. In an example basic configuration 602, the computing device 600 may include one or more processors 604 and a system memory 606. A memory bus 608 may be used for communication between the processor 604 and the system memory 606. The basic configuration 602 may be illustrated in FIG. 6 by those components within the inner dashed line.

Depending on the desired configuration, the processor 604 may be of any type, including but not limited to a microprocessor (μP), a microcontroller (μC), a digital signal processor (DSP), an application-specific integrated circuit (ASIC), a field-programmable gate array (FPGA), programmable logic device (PLD), a free form logic on an integrated circuit (IC) or other or any combination thereof. The processor 604 may include one or more levels of caching, such as a level cache memory 612, one or more processor cores 614, and registers 616. The example processor cores 614 may (each) include an arithmetic logic unit (ALU), a floating point unit (FPU), a digital signal processing core (DSP Core), or any combination thereof. An example memory controller 618 may also be used with the processor 604, or in some implementations, the memory controller 618 may be an internal part of the processor 604.

Depending on the desired configuration, the system memory 606 may be of any type including but not limited to volatile memory (such as RAM), non-volatile memory (such as ROM, flash memory, etc.), or any combination thereof. The system memory 606 may include an operating system 620, a enhancement application 622, and a program data 624. The enhancement application 622 may include components such as an analysis module 626 and a presentation module 627. The analysis module 626 and the presentation module 627 may execute the processes associated with the enhancement application 622. The analysis module 626 may retrieve performance and/or configuration data associated with existing products or services from a data source. The performance and/or configuration data may be analyzed to generate a model of success factor(s) associated with the existing products or services. Next, configuration conditions of a current product or service may be received from a stakeholder. In response, predicted score(s) may be computed for the success factor(s) using the model by simulating the configuration conditions of the current product or service on the model. The presentation module 627 may provide the predicted score(s) or suggestion(s) to achieve the predicted score(s) in a visualization to the stakeholder.

Input to and output out of the enhancement application 622 may be transmitted through a communication device associated with the computing device 600. An example of the communication device may include a networking device that may be communicatively coupled to the computing device 600. The networking device may provide wired and/or wireless communication. The program data 624 may also include, among other data, performance and/or configuration data 628, or the like, as described herein. The performance and/or configuration data 628 may include success measurements, among others.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices may include magnetic disk devices, such as flexible disk drives and hard-disk drives (HDDs), optical disk drives such as compact disk (CD) drives or digital versatile disk (DVD) drives, solid state drives (SSDs), and tape drives, to name a few. Example computer storage media may include volatile and nonvolatile, removable, and non-removable media implemented in any method or technology for storage of information, such as computer-readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (for example, one or more output devices 642, one or more peripheral interfaces 644, and one or more communication devices 666) to the basic configuration 602 via the bus/interface controller 630. Some of the example output devices 642 include a graphics processing unit 648 and an audio processing unit 650, which may be configured to communicate to various external devices such as a display or speakers via one or more A/V ports 652. One or more example peripheral interfaces 644 may include a serial interface controller 654 or a parallel interface controller 656, which may be configured to communicate with external devices such as input devices (for example, keyboard, mouse, pen, voice input device, touch input device, etc.) or other peripheral devices (for example, printer, scanner, etc.) via one or more I/O ports 658. An example of the communication device(s) 666 includes a network controller 660, which may be arranged to facilitate communications with one or more other computing devices 662 over a network communication link via one or more communication ports 664. The one or more other computing devices 662 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 600 may be implemented as a part of a general purpose or specialized server, mainframe, or similar computer, which includes any of the above functions. The computing device 600 may also be implemented as a personal computer including both laptop computer and non-laptop computer configurations.

Example embodiments may also include methods to enhance a product or service by optimizing success factors associated with the product or service. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

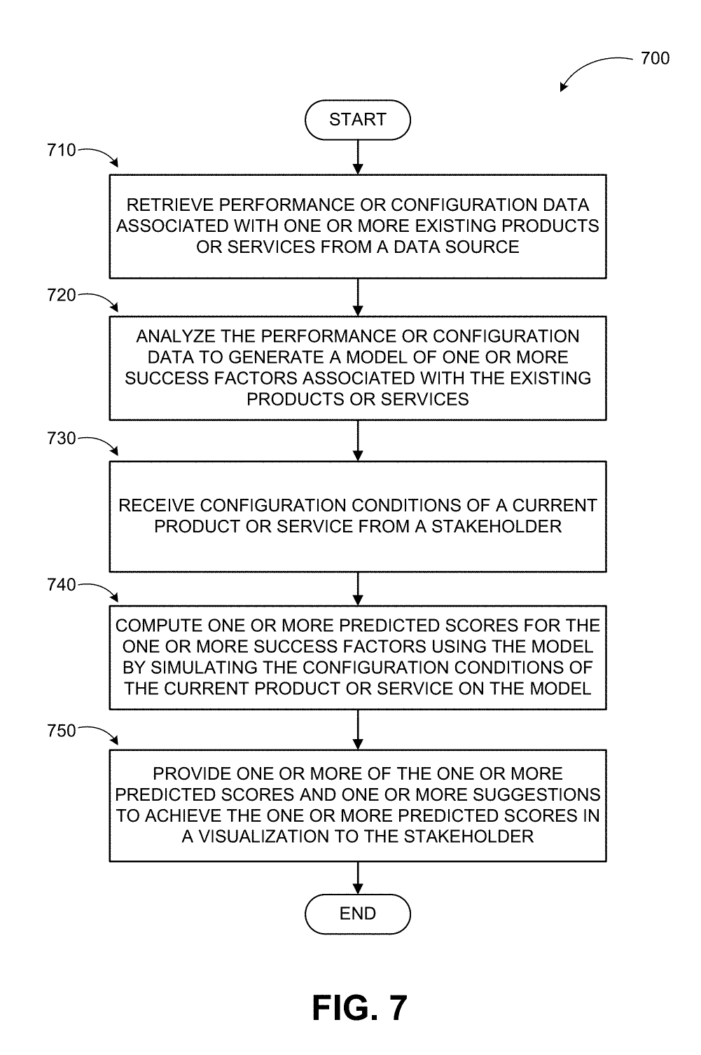

FIG. 7 is a logic flow diagram illustrating a process for enhancing a product or service by optimizing success factors associated with the product or service, according to embodiments. Process 700 may be implemented on a computing device, such as the computing device 600 or another system.

Process 700 begins with operation 710, where the enhancement application retrieves performance and/or configuration data associated with existing products or services from a data source. The performance and/or configuration data may include an acquisition, a price, a revenue, a social media share, a usage, a description, a promotion, an advertising, a media, a metadata, and/or a content, among others associated with the existing products or services. Next, the performance and/or configuration data is analyzed to generate a model of one or more success factors associated with the existing products or services at operation 720. The success factors may include a description, a promotion, a price, an advertising, a media, a metadata, or a content, among others associated with the existing products or services. At operation 730, configuration conditions of a current product or service may be received from a stakeholder.

Next, at operation 740, predicted score(s) for the success factor(s) may be computed using the model by simulating the configuration conditions of the current product or service on the model. At operation 750, the predicted score(s) or suggestion(s) to achieve the predicted score(s) may be provided in a visualization to the stakeholder. The visualization may include a report, a chart, a document, and/or a presentation, among others.

The operations included in process 700 are for illustration purposes. Enhancing a product or service by optimizing one or more success factors associated with the product or service may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

In some examples, a computing device to enhance a product or a service by optimizing one or more success factors of the product or service is described. The computing device includes a communication device, a memory configured to store instructions associated with an enhancement application, one or more processors coupled to the memory and the communication device. The one or more processors execute the enhancement application in conjunction with the instructions stored in the memory. The enhancement application includes an analysis module and a presentation module. The analysis module is configured to retrieve, through the communication device, performance and/or configuration data associated with one or more existing products or services from a data source, analyze the performance and/or configuration data to generate a model of one or more success factors associated with the existing products or services, receive, through the communication device, configuration conditions of a current product or service from a stakeholder, compute one or more predicted scores for the one or more success factors using the model by simulating the configuration conditions of the current product or service on the model. The presentation module is configured to provide, through the communication device, one or more of the one or more predicted scores and one or more suggestions to achieve the one or more predicted scores in a visualization to the stakeholder.

In other examples, the performance and/or configuration data include one or more of an acquisition, a price, a number of sales, a revenue, a social media share, a usage, a description, a promotion, an advertising, a media, a metadata, and/or a content associated with the existing products or services. The one or more suggestions include a change to one or more success factors that include one or more of a description, a promotion, a price, an advertising, a media, a metadata, and a content associated with the current product or service. The analysis module is further configured to process the performance and/or configuration data through a machine-learning scheme to identify the one or more success factors. The machine-learning scheme includes one or more of a boosted decision regression scheme, a linear scheme, a Bayesian linear scheme, a decision forest scheme, a fast forest quantile scheme, a neural network scheme, a Poisson scheme, and/or an ordinal scheme, among others.

In further examples, the analysis module is further configured to filter the performance and/or configuration data through one or more decision nodes to identify a selection of the performance and/or configuration data from which to generate the model. The one or more decision nodes correlate to the success factors of the one or more existing products or services. The analysis module is further configured to remove a redundant decision node from the one or more decision nodes in response to detecting a redundancy within the one or more decision nodes. The analysis module is further configured to apply a weight factor to each of the one of more decision nodes, wherein the weight factor is configured to distinguish the one or more success factors that are likely to contribute to a success of the current product or service. The analysis module is further configured to modify the model by adjusting the weight factor for each of the one or more decision nodes in response to a determination that the one or more predicted scores are greater than a current score of the current product or service. The analysis module is further configured to remove a processed decision node from the one or more decision nodes in response to a failure to adjust the weight factor to adjust the model for an improvement to a success of the current product or service, wherein the model computes the one or more predicted scores that are lower than a current score of the current product or service.

In some examples, a method executed on a computing device to enhance a product or service by optimizing one or more success factors associated with the product or service. The method includes retrieving performance and/or configuration data associated with one or more existing products or services from a data source, wherein the performance and/or configuration data includes one or more of an acquisition, a price, a number of sales, a revenue, a social media share, a usage, a description, a promotion, an advertising, a media, a metadata, and/or a content associated with the current product or service, analyzing the performance and/or configuration data to generate a model of one or more success factors associated with an existing product or service, receiving configuration conditions of a current product or service from a stakeholder, computing one or more predicted scores for the one or more success factors using the model by simulating the configuration conditions of the current product or service on the model, and providing one or more of the one or more predicted scores and one or more suggestions to achieve the one or more predicted scores in a visualization to the stakeholder.

In other examples, the method further includes validating the one or more predicted scores by providing a previous version of the current product or service that does not incorporate the one or more suggestions and a suggested version of the current product or service that does incorporate the one or more suggestions to one or more consumers, tracking a first success measurement associated with the previous version of the current product or service and a second success measurement associated with the suggested version of the current product or service, and comparing the first success measurement and the second success measurement. The method further includes in response to detecting the second success measurement as greater than the first success measurement, validating the one or more predicted scores. The method further includes in response to detecting the first success measurement as greater than the second success measurement, invalidating the one or more predicted scores.

In further examples, the method further includes processing the performance and/or configuration data to expand the model to compute one or more additional predicted scores, wherein the model simulates another implementation of one or more additional suggestions to the current product or service and computing the one or more additional predicted scores using the model. The method further includes presenting a new visualization that includes the one or more predicted scores, the one or more suggestions, the one or more additional predicted scores and the one or more additional suggestions, wherein the one or more suggestions includes one or more changes to the configuration conditions of the current product or service and one or more additional changes to the configuration conditions of the current product or service.

In some examples, a computer-readable memory device with instructions stored thereon to enhance a product or service by optimizing one or more success factors associated with the product or service is described. The computer-readable memory device includes actions that are similar to the actions of the method. The instructions further include generating an abstraction of the predicted score, wherein the abstraction includes a percentage value of a previous predicted score associated with a previous version of the current product or service and a binary value that specifies an improvement or a decline of a success of the current product or service and providing the abstraction in the visualization.

In some examples, a means for enhancing a product or a service by optimizing one or more success factors of the product or service is described. The means for enhancing a product or a service by optimizing one or more success factors of the product or service includes a means for retrieving performance and/or configuration data associated with one or more existing products or services from a data source, a means for analyzing the performance and/or configuration data to generate a model of one or more success factors associated with the existing products or services, a means for receiving configuration conditions of a current product or service from a stakeholder, a means for computing one or more predicted scores for the one or more success factors using the model by simulating the configuration conditions of the current product or service on the model, and a means for providing one or more of the one or more predicted scores and one or more suggestions to achieve the one or more predicted scores in a visualization to the stakeholder.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A computing device to enhance a product or service by optimizing one or more success factors of the product or service, the computing device comprising:
a communication device;
a memory configured to store instructions associated with an enhancement application;
one or more processors coupled to the memory and the communication device, the one or more processors executing the enhancement application in conjunction with the instructions stored in the memory, wherein the enhancement application includes:
an analysis module configured to:
retrieve, through the communication device, performance and/or configuration data associated with one or more existing products or services from a data source;
analyze the performance and/or configuration data to generate a model of one or more success factors associated with the existing products or services;
receive, through the communication device, configuration conditions of a current product or service from a stakeholder;
compute one or more predicted scores for the one or more success factors using the model by simulating the configuration conditions of the current product or service on the model; and
a presentation module configured to:
provide, through the communication device, one or more of the one or more predicted scores and one or more suggestions to achieve the one or more predicted scores in a visualization to the stakeholder.

2. The computing device of claim 1, wherein the performance and/or configuration data include one or more of an acquisition, a price, a number of sales, a revenue, a social media share, a usage, a description, a promotion, an advertising, a media, a metadata, and a content associated with the one or more existing products or services.

3. The computing device of claim 1, wherein the one or more suggestions include a change to the one or more success factors that include one or more of a description, a promotion, a price, an advertising, a media, a metadata, and a content associated with the current product or service.

4. The computing device of claim 1, wherein the analysis module is further configured to:
process the performance and/or configuration data through a machine-learning scheme to identify the one or more success factors.

5. The computing device of claim 4, wherein the machine-learning scheme includes one or more of a boosted decision regression scheme, a linear scheme, a Bayesian linear scheme, a decision forest scheme, a fast forest quantile scheme, a neural network scheme, a Poisson scheme, and an ordinal scheme.

6. The computing device of claim 1, wherein the analysis module is further configured to:
filter the performance and/or configuration data through one or more decision nodes to identify a selection of the performance and/or configuration data from which to generate the model.

7. The computing device of claim 6, wherein the one or more decision nodes correlate to the success factors of the one or more existing products or services.

8. The computing device of claim 6, wherein the analysis module is further configured to:
remove a redundant decision node from the one or more decision nodes in response to detecting a redundancy within the one or more decision nodes.

9. The computing device of claim 6, wherein the analysis module is further configured to:
apply a weight factor to each of the one of more decision nodes, wherein the weight factor is configured to distinguish the one or more success factors that are likely to contribute to a success of the current product or service.

10. The computing device of claim 9, wherein the analysis module is further configured to:
modify the model by adjusting the weight factor for each of the one or more decision nodes in response to a determination that the one or more predicted scores are greater than a current score of the current product or service.

11. The computing device of claim 9, wherein the analysis module is further configured to:
remove a processed decision node from the one or more decision nodes in response to a failure to adjust the weight factor to adjust the model for an improvement to a success of the current product or service, wherein the model computes the one or more predicted scores that are lower than a current score of the current product or service.

12. A method executed on a computing device to enhance a product or service by optimizing one or more success factors associated with the product or service, the method comprising:
retrieving performance and/or configuration data associated with one or more existing products or services from a data source, wherein the performance and/or configuration data includes one or more of an acquisition, a price, a number of sales, a revenue, a social media share, a usage, a description, a promotion, an advertising, a media, a metadata, and a content associated with the current product or service;
analyzing the performance and/or configuration data to generate a model of one or more success factors associated with an existing product or service;
receiving configuration conditions of a current product or service from a stakeholder;
computing one or more predicted scores for the one or more success factors using the model by simulating the configuration conditions of the current product or service on the model; and
providing one or more of the one or more predicted scores and one or more suggestions to achieve the one or more predicted scores in a visualization to the stakeholder.

13. The method of claim 12, further comprising:
validating the one or more predicted scores by providing a previous version of the current product or service that does not incorporate the one or more suggestions and a suggested version of the current product or service that does incorporate the one or more suggestions to one or more consumers;
tracking a first success measurement associated with the previous version of the current product or service and a second success measurement associated with the suggested version of the current product or service; and
comparing the first success measurement and the second success measurement.

14. The method of claim 13, further comprising:
in response to detecting the second success measurement as greater than the first success measurement, validating the one or more predicted scores.

15. The method of claim 13, further comprising:
in response to detecting the first success measurement as greater than the second success measurement, invalidating the one or more predicted scores.

16. The method of claim 12, further comprising:
processing the performance and/or configuration data to expand the model to compute one or more additional predicted scores, wherein the model simulates another implementation of one or more additional suggestions to the current product or service; and
computing the one or more additional predicted scores using the model.

17. The method of claim 16, further comprising:
presenting a new visualization that includes the one or more predicted scores, the one or more suggestions, the one or more additional predicted scores and the one or more additional suggestions, wherein the one or more suggestions includes one or more changes to the configuration conditions of the current product or service and one or more additional changes to the configuration conditions of the current product or service.

18. A computer-readable memory device with instructions stored thereon to enhance a product or service by optimizing one or more success factors associated with the product or service, the instructions comprising:
retrieving performance and/or configuration data associated with one or more existing products or services from a data source, wherein the performance and/or configuration data includes one or more of an acquisition, a price, a number of sales, a revenue, a social media share, a usage, a description, a promotion, an advertising, a media, a metadata, and a content associated with the current product or service;
analyzing the performance and/or configuration data to generate a model of one or more success factors associated with an existing product or service;
receiving configuration conditions of a current product or service from a stakeholder;
computing one or more predicted scores for the one or more success factors using the model by simulating the configuration conditions of the current product or service on the model; and
providing one or more of the one or more predicted scores and one or more suggestions to achieve the one or more predicted scores in a visualization to the stakeholder.

19. The computer-readable memory device of claim 18, wherein the instructions further comprise:
generating an abstraction of the predicted score, wherein the abstraction includes a percentage value of a previous predicted score associated with a previous version of the current product or service and a binary value that specifies an improvement or a decline of a success of the current product or service; and
providing the abstraction in the visualization.

20. The computer-readable memory device of claim 18, wherein the instructions further comprise:
processing the performance and/or configuration data to expand the model to compute one or more additional predicted scores of one or more additional success metrics, wherein the model simulates another application of one or more additional suggestions to the product or service;
computing the one or more additional predicted scores using the model; and
presenting a new visualization that includes the predicted score, the suggestion, the one or more additional predicted scores and the one or more additional suggestions, wherein the suggestion includes a change to the configuration conditions of the current product or service and one or more additional changes to the configuration conditions of the current product or service.
